(19) United States
(12) Patent Application Publication
(10) Pub. No.: US 2016/0313017 A1
(43) Pub. Date: Oct. 27, 2016

(54) Apparatus and Method for Improving Airflow to a Room

(71) Applicant: Stanford Nauls, Houston, TX (US)

(72) Inventor: Stanford Nauls, Houston, TX (US)

(21) Appl. No.: 14/692,565

(22) Filed: Apr. 21, 2015

(51) Int. Cl. F24F 7/06; F24F 7/10; B23P 19/00

(52) U.S. Cl. CPC F24F 7/065; B23P 19/00; F24F 7/10

(57) ABSTRACT

Embodiments of the invention include an apparatus and method for improving airflow to a room using a ducting and venting apparatus. The apparatus can include a register box having a first side with a substantially circular flange that extends outwardly from a substantially flat surface of the first side. The flange is adapted to attach to a duct of an HVAC system. The second side further can be adapted to attach to an air register or a second substantially circular flange. Positioned within the box is an axial fan that is adapted to direct airflow from inside the duct to the room during operation of the fan. Method embodiments can include attaching an apparatus to an interior surface of a structure, attaching a duct to the flange of the first side of the apparatus, and power the apparatus with 110 VAC.

### BACKGROUND OF THE INVENTION

1. Field of the Invention

Embodiments of the invention relate to a ducting and venting apparatus and corresponding methods for a Heating, ventilating, and air conditioning (“HVAC”) system.

2. Description of the Related Art

HVAC systems provide thermal comfort and indoor air quality. At times, there is a room or space in a structure that does not get the appropriate amount of air flow. This room or space is often the room or space that is further from the HVAC unit and is hotter or colder than other areas in the structure. Embodiments of the invention are directed to addressing one or more of the forgoing problems.

### SUMMARY OF THE INVENTION

Embodiments of the invention are directed to improving airflow to a room in a structure using a ducting and venting apparatus. The ducting and venting apparatus includes, for example, a register box having a first side and a second side, the first side having a substantially circular flange that extends outwardly from a substantially flat surface of the first side. The flange is adapted to attach to a duct of an HVAC system, and the second side adapted to face a room when the first side is attached to the duct. According to one or more embodiments, the second side further adapted to attach to an air register to further facilitate flow to the room. The apparatus can further include, for example, an axial fan positioned within the register box and adapted to direct airflow from inside the duct to the room during operation of the fan. During operation of the fan, airflow travels from the duct through the flange of the first side, to the second side, and to the room. The apparatus can also include a switch adapted to rotate the fan at multiple speeds using 110 volts alternating current. The switch can be, for example, a potentiometer.

An alternative embodiment of the ducting and venting apparatus includes, for example, a registry box having a first and second side, each side having a substantially circular flange that extends outwardly therefrom. Each flange is adapted to attach to a separate duct of the HVAC system. The duct adapted to be attached to the second side providing airflow to a room indirectly or directly. The axial fan is positioned within the box to increase airflow through the duct attached to the second side during operation. The alternative embodiment can be positioned, for example, within an attic of a structure.

Embodiments of the invention further include methods of installing and operating a ducting and venting apparatus to improve airflow to a room. The method including, for example, attaching a ducting and venting apparatus to an interior surface of a structure, the apparatus including a register box having a first side and a second side, the first side having a substantially circular flange that extends outwardly from a substantially flat surface of the first side. The apparatus further including an axial fan positioned within the register box to facilitate airflow. The method can further include the step of attaching a duct to the flange of the first side of the apparatus and powering the apparatus with a 110 volts alternating current, the fan of the apparatus adapted to rotate at a plurality of speeds using a switch. Operation of the fan thereby causing airflow to be drawing from inside the duct attached to the second side through the flange, out the first side, and to the room.

### BRIEF DESCRIPTION OF THE DRAWINGS

So that the manner in which the features and advantages of embodiments of the invention, as well as others, which will become apparent, may be understood in more detail, a more particular description of embodiments of the invention briefly summarized above may be had by reference to the embodiments thereof, which are illustrated in the appended drawings form a part of this specification. It is to be noted, however, that the drawings illustrate only various embodiments of the invention and are therefore not to be considered limiting of the inventions' scope, which may include other effective embodiments as well.

FIG. 1 is an environmental view of the ducting and venting apparatus according to an embodiment of the invention.

FIG. 2 illustrates a second side of the registry box of the ducting and venting apparatus in FIG. 1 according to an embodiment of the invention.

FIG. 3 illustrates a first side of the registry box of the ducting and venting apparatus in FIG. 1 according to an embodiment of the invention.

FIG. 4 is a close up view of the fan illustrated in FIG. 3 according to an embodiment of the invention.

### DETAILED DESCRIPTION

So that the manner in which the features and advantages of embodiments of the invention, as well as others, which will become apparent, may be understood in more detail, a more particular description of embodiments of the invention briefly summarized above may be had by reference to the embodiments thereof, which are illustrated in the appended drawings form a part of this specification. It is to be noted, however, that the drawings illustrate only various embodiments of the invention and are therefore not to be considered limiting of the inventions' scope, which may include other effective embodiments as well.

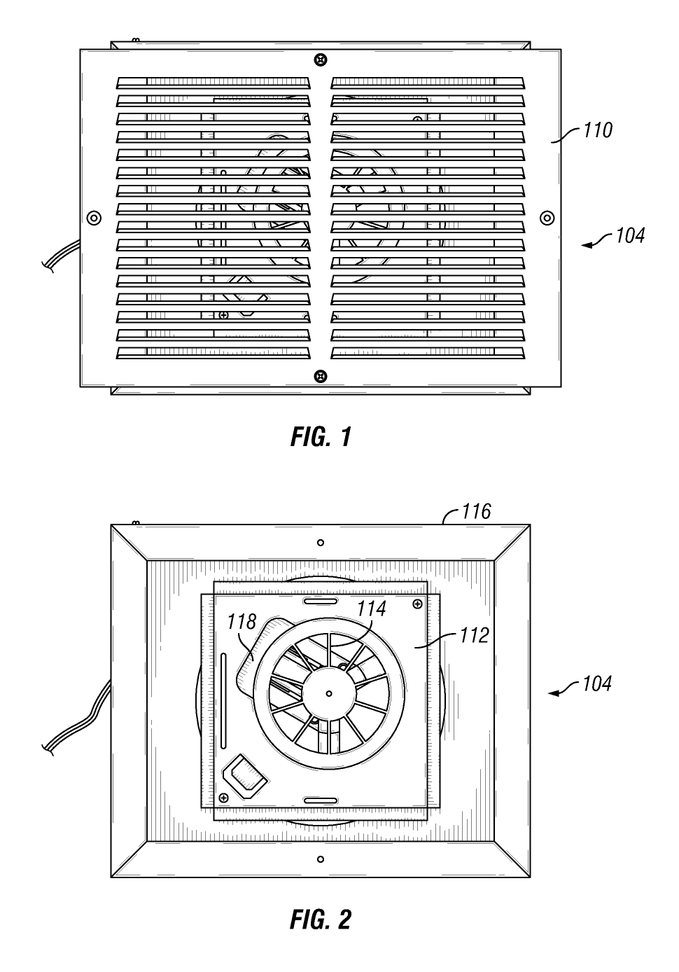

Embodiments of the invention are directed to improving airflow to a room, area, or space (herein referred to collectively as a “room”) of a residential or commercial structure. FIG. 1 illustrates an environmental ducting and venting apparatus according to an embodiment of invention. The apparatus can be positioned in or attached to the ceiling, floor, or wall of the room. According to an alternative embodiment (not shown), the apparatus can be positioned in the attic of a structure. Airflow provided by a HVAC system is often shared by a plurality of ducts. The apparatus is adapted to pull more air from the ducts of the HVAC system to the room that the apparatus is facilitating.

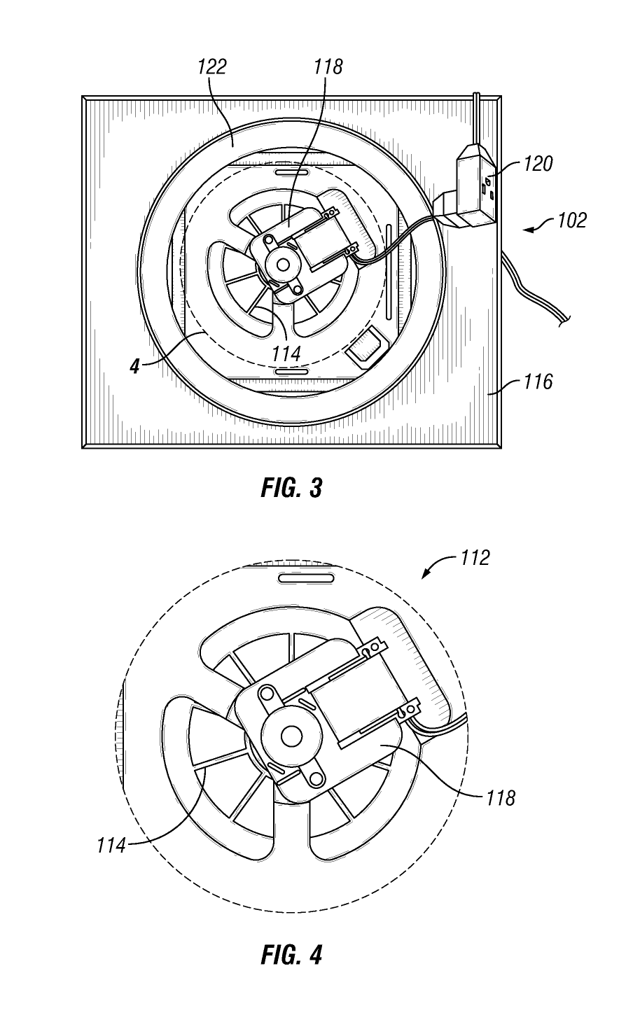

The apparatus includes a register box 116 that is adapted to provide a transition from round duct pipe or insulated flexible duct to an air grille 114. FIGS. 2 and 3 illustrate a respective first 102 and second 104 side of the box 116 illustrated in FIG. 1. The register box 116 be a conventional box that is made of galvanized steel and can be attached to a ceiling, wall, or floor, for example, according to an embodiment of the invention. As illustrated in FIG. 3, for example, a first side 102 of the box can include a substantially circular flange 122 that extends outwardly from a substantially flat surface of the first side 102. The flange 122 is adapted to be attached to a duct of an HVAC system using, for example, a clamp, duct tape, mastics adhesives, other types of adhesives, and/or other attachment means as understood by those skilled in the art. The diameter of the flange 122 varies according to the diameter of the duct to be attached. For example, according to an embodiment of the invention, the flange 122 is adapted to attach to an six (6), eight (8), ten (10), or twelve (12) inch duct as understood by those skilled in the art.

The second side 104 of the box 116 is adapted to face the room to which airflow is to be provide to when the apparatus is attached to an interior surface of the room. According to some embodiments, the air grille 110 is attached to the second side 104 of the apparatus to further facilitate airflow to the room (see e.g., FIG. 1). The grille 110 may also include a damper that controls the opening and closing of the grille to facilitate the control of the direction and the amount of the airflow through the grille. For example, the damper of the grille 110 can close the vents of the grille so that substantially no air flows through the grille. The damper can also partially close the vents or close some of the vents of the grille to provide less airflow through the grille 110. The apparatus can be positioned such that at least part of the grille 110 is positioned within the room.

Positioned inside the box 116 is an axial fan 112 adapted to direct airflow from inside the duct to the room during operation of the fan and/or the HVAC system. According to an embodiment, impellers 114 of the fan 112 direct air to move substantially parallel to the shaft about which the blades rotate thereby causing air to travel during operation from inside the duct, through the first 102 and second 104 sides of the apparatus respectively, and to the room. The fan 112 also includes a fan housing that is attached to one or more inside surfaces of the box 116 as illustrated in FIG. 2, for example. An embodiment of the fan housing includes substantially flat first and second sides that are parallel to the respective first 102 and second 104 sides of the box 116 when the fan 112 is positioned within the box 116.

Attached to the first side of the fan housing is a motor 118 of the fan, as illustrated in FIG. 3. FIG. 4 also illustrates a close up of the fan 112 illustrated in FIG. 3 according to an embodiment of the invention. According to certain embodiments, for example, the motor 118 delivers 50-70 cubic feet per minute (CFM) of power to the fan 112. As will be understood by those skilled in the art, the size and power of the fan 112 will vary according to the size of the room to which the apparatus is facilitating airflow to. Positioned adjacent to the second side of the fan housing are the impellers 114 of the fan, as illustrated in FIG. 2, for example. The positioning of the impellers 114 advantageously causes the fan 112 to draw air from the duct to the room during operation of the fan and/or the HVAC system.

As further illustrated in FIG. 3, the apparatus can further include a switch 120 to control the speed of the rotation of the fan 112. The switch can be, for example, a standard dimmer used for lights. The switch can be, for example, a potentiometer. The switch can also be connected to a ceiling fan in the same room as the apparatus. According to an embodiment of the invention, the apparatus is powered by 110 volts alternating current.

According to an alternative embodiment of the apparatus, the first side 102 of the box 116 includes a first substantially circular flange and the second side 104 of the box 116 includes a second substantially circular flange. Each flange is adapted to attach to separate ducts of an HVAC system or separate ends of a duct of an HVAC system. The duct that is adapted to be attached to the second flange is adapted to provide airflow to a room. The diameter of the flange can vary based on the diameter of the duct that is to be attached thereto. For example, one or more of the flanges can be attached to a duct having a diameter of six (6), eight (8), ten (10), or twelve (12) inches as understood by those skilled in the art.

According to the alternative embodiment, the axial fan is positioned within the register box 116 and is adapted to increase airflow through the duct attached to the second side of the box during operation of the fan 112 and/or the HVAC system. The fan 112 includes a fan housing that is attached to one or more inner surfaces of the box 116, with a motor 118 of the fan being attached to a first side of the fan housing that faces and is substantially parallel to the first side of the box when attached thereto. The second side of the fan housing is adjacent to the impellers 114 of the fan. The fan 112 is controlled by a switch 120 adapted to rotate the fan at a plurality of speeds. As will be appreciated by those skilled in the art, this embodiment of the apparatus can be positioned within the attic of a structure and near a furnace of a HVAC system.

Embodiments of the invention also include a method of installing and operating a ducting and venting apparatus to improve airflow to a room. Method embodiments can include, for example, attaching the ducting and venting apparatus to an interior surface of a structure. The interior surface can be, for example, the ceiling, wall, or floor of a room, or in the attic of a structure. The method can further include, for example, attaching a duct to a substantially circular flange 122 on the first side 102 of the box 116 of the apparatus. The duct can be attached using, for example, a clamp, duct tape, mastics adhesives, other types of adhesives, and/or other attachment means as understood by those skilled in the art. In certain embodiments, the method further includes attaching a second substantially circular flange on the second side 104 of the box to a second duct. In other embodiments, the method includes attaching an air grille 110 to the second side 104 of the box 116. In this embodiment, the air grille 110 is at least partially positioned within the room on a wall, ceiling, or floor surface. The fan can cause airflow to increase through the second side 104 of the box so that airflow to the room is improved.

A method embodiment of the present invention can further include powering the apparatus with 110 volts alternating current and controlling the speed of the rotation of the fan 112 using a switch. The switch, for example, can enable a user to operate the fan at high, medium, and low speeds. According to an embodiment of the invention, the switch can connected to a ceiling fan. This configuration may be useful for installing the apparatus to an existing construction. In other embodiments, the switch can be a standard dimmer or light switch as understood by those skilled in the art. This configuration may be useful for installing the apparatus to new structure construction or when there is a substantial rehabilitation to the room being serviced by the apparatus.

Embodiments of the invention can include installing a plurality of the ducting and venting apparatuses in a structure. Some rooms will have a plurality of apparatuses installed in the same room. For example, a first apparatus may be installed in the ceiling and a second apparatus may be installed in the wall of the room. Alternatively, a first apparatus may be installed in the attic and a second apparatus may be installed in the wall or ceiling of the room. As will be understood by those skilled in the art, multiple configurations are contemplated by embodiments of the invention. The number of apparatuses that service a room can also vary based on the size of the room and/or one or more features of the HVAC system.

In the drawings and specification, there have been disclosed embodiments of the embodiments of the present invention, and although specific terms are employed, the terms are used in a descriptive sense only and not for purposes of limitation. The embodiments of the present invention have been described in considerable detail with specific reference to these illustrated embodiments. It will be apparent, however, that various modifications and changes can be made within the spirit and scope of the embodiments of the present invention as described in the foregoing specification, and such modifications and changes are to be considered equivalents and part of this disclosure.

That claimed is:

1. A ducting and venting apparatus to improve airflow to a room, the apparatus comprising:
a register box having a first side and a second side, the first side having a substantially circular flange that extends outwardly from a substantially flat surface of the first side, the flange adapted to attach to a duct of an HVAC system, the second side adapted to face a room when the first side is attached to the duct, the second side further adapted to attach to an air register;
an axial fan positioned within the register box and adapted to direct airflow from inside the duct to the room during operation of the fan, airflow traveling from the duct through the flange of the first side and to the room during operation of the fan; and
a switch adapted to control the fan, the fan adapted to rotate at a plurality of speeds.

2. The apparatus of claim 1, wherein the substantially circular flange is adapted to attach to the duct having a diameter of one of the following: 6 inches, 8 inches, 10 inches, and 12 inches.

3. The apparatus of claim 1, wherein the register box is adapted to be attached to the ceiling of the room.

4. The apparatus of claim 1, wherein the apparatus is adapted to be connected to a ceiling fan and the switch is adapted to control speeds of the ceiling fan and the apparatus.

5. The apparatus of claim 1, wherein the apparatus is adapted to powered by a 110 volts alternating current.

6. The apparatus of claim 1, wherein the fan includes a fan housing that is attached to one or more inside surfaces of the register box, a motor of the fan being attached to a first side of the fan housing that faces and is substantially parallel to the first side of the register box when attached thereto, impellers of the fan being on a second side of the fan housing that faces and is substantially parallel to the second side of the register box when attached thereto.

7. A ducting and venting apparatus to improve airflow to a room, the apparatus comprising:
a register box having a first side and a second side, each side having a substantially circular flange that extends outwardly therefrom, each flange adapted to attach to a duct of an HVAC system, the duct adapted to be attached to the second side providing airflow to a room;
an axial fan positioned within the register box and adapted to increase airflow through the duct attached to the second side of the register box during operation of the fan; and
a switch adapted to control the fan, the fan adapted to rotate at a plurality of speeds.

8. The apparatus of claim 7, wherein the apparatus is adapted to be positioned in an attic of a structure.

9. The apparatus of claim 7, wherein the fan includes a fan housing that is attached to one or more inside surfaces of the register box, a motor of the fan being attached to a first side of the fan housing that faces and is substantially parallel to the first side of the register box when attached thereto, impellers of the fan being on a second side of the fan housing that faces and is substantially parallel to the second side of the register box when attached thereto.

10. The apparatus of claim 7, wherein the substantially circular flanges are adapted to attach to one or more ducts having a diameter of one or more of the following: 6 inches, 8 inches, 10 inches, and 12 inches.

11. The apparatus of claim 7, wherein the apparatus is adapted to be connected to a ceiling fan and the switch is adapted to control the speed of the ceiling fan and the apparatus.

12. The apparatus of claim 7, wherein the apparatus is adapted to powered by a 110 volts alternating current.

13. A method of installing a ducting and venting apparatus to improve airflow to a room, the method comprising:
attaching a ducting and venting apparatus to an interior surface of a structure, the apparatus including a register box having a first side and a second side, the first side having a substantially circular flange that extends outwardly from a substantially flat surface of the first side, the apparatus further including an axial fan positioned within the register box to facilitate airflow;
attaching a duct to the flange of the first side of the apparatus; and
powering the apparatus with a 110 volts alternating current, the fan of the apparatus adapted to rotate at a plurality of speeds using a switch.

14. The method of claim 13, wherein the surface that the apparatus is attached to is in the attic of the structure, wherein the duct is a first duct and the flange is a first flange; and wherein the method further comprises the step of attaching a second duct to a second substantially circular flange that extends outwardly from a substantially flat surface of the second side of the apparatus, the fan adapted to improve airflow through the second duct to the room in the structure.

15. A method of claim 13, wherein the surface that the apparatus is attached to is the ceiling of the room in the structure, and wherein the second side is adapted to face the room in the structure when the first side is attached to the duct, the second side further adapted to attach to an air register that at least partially outwardly faces the room.

16. A method of claim 15, wherein the apparatus is adapted to be connected to a ceiling fan and the switch is adapted to control the speed of the ceiling fan and the apparatus.

17. A method of claim 15, wherein the fan includes a fan housing that is attached to one or more inside surfaces of the register box, a motor of the fan being attached to a first side of the fan housing that faces and is substantially parallel to the first side of the register box when attached thereto, impellers of the fan being on a second side of the fan housing that faces and is substantially parallel to the second side of the register box when attached thereto.

18. A method of claim 14, wherein the fan includes a fan housing that is attached to one or more inside surfaces of the register box, a motor of the fan being attached to a first side of the fan housing that faces and is substantially parallel to the first side of the register box when attached thereto, impellers of the fan being on a second side of the fan housing that faces and is substantially parallel to the second side of the register box when attached thereto.

19. A method of claim 13, wherein the substantially circular flange is adapted to attach to the duct having a diameter of one of the following: 6 inches, 8 inches, 10 inches, and 12 inches.

20. A method of claim 13, wherein one or more components of the register box are constructed of galvanized steel.
